(19) United States
(12) Patent Application Publication
(10) Pub. No.: US 2007/0226185 A1
(43) Pub. Date: Sep. 27, 2007

(54) Method and apparatus for customizable search parameters

(76) Inventor: Wolfgang E. Walter, Hambrucken (DE)

Correspondence Address: SAP/BLAKELY, 1279 OAKMEAD PARKWAY, SUNNYVALE, CA, 94085-4040, US

(21) Appl. No.: 11/388,411

(22) Filed: Mar. 24, 2006

(51) Int. Cl. G06F 17/30

(52) U.S. Cl. 707/3

(57) ABSTRACT

Entries for one or more search parameters are accepted from a user, then the entries are saved as a preconfigured search in one of several storage classes. Values for a preconfigured search can be retrieved, displayed and modified if not locked, and then used to perform a search.

### FIELD

The invention relates to data entry operations. More specifically, the invention relates to features to improve efficiency of searching operations.

### BACKGROUND

Many business processes involve data entry operations at one or more points. Consider, for example, a supply chain involving several businesses that cooperate to transform raw materials into a finished product. Each business may track its own inventory, order supplies from an upstream partner, and send goods to a downstream customer. The number and complexity of records processing systems may be proportional to the number and quantity of products handled, the number of suppliers and the number of customers. Accurate, timely data may be critical to the efficient operation of each business.

Data entry may be considered an unskilled or low-skilled task, but the fast and accurate performance of that task may be enormously valuable. Systems and methods to streamline data entry tasks—which may include operations beyond straightforward typing or scanning of information into a database—can contribute significantly to a business's bottom line.

### SUMMARY

Embodiments of the invention provide configurable search parameter facilities to speed certain data retrieval operations. Search parameters may be saved in various classes so that the most relevant preconfigured searches are readily available to the users who need them.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample data entry screen and several sub-screens that can be reached from the main screen.

FIG. 2 is a flow chart of operations that may be involved in invoking a search.

FIG. 3 shows how a preconfigured search may be prepared.

FIG. 4 shows a sample search screen and a sub-screen to store search parameters as a preconfigured search.

FIG. 5 shows a logical structure of a supply chain management application that can use an embodiment of the invention.

### DETAILED DESCRIPTION

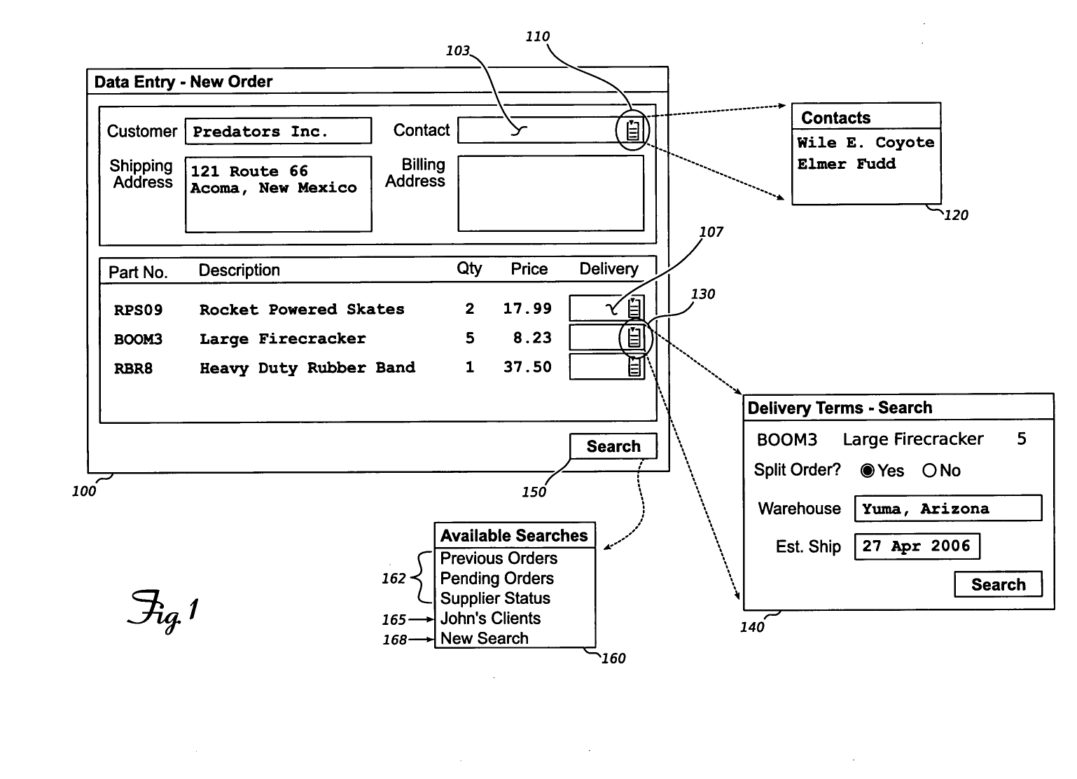

FIG. 1 shows a sample order entry screen 100 containing a number of fields of information that a clerk may enter. Some fields may refer to data stored elsewhere in the system. For example, the “contact” field 103 may be required to contain the name of one of a few registered customer contacts (to prevent orders being placed by arbitrary, putative representatives of the customer). One way to deal with fields like this is to permit the entry of an arbitrary name, then check the name against the registered contacts to confirm that the person may properly place an order. Another way is to provide a search function so that the clerk can retrieve a list of registered contacts and select an acceptable name from the list. The second approach may permit faster and more accurate data entry.

Other fields in a data entry screen may depend on information in the database in a more complex way. For example, a “delivery” field 107 for an item may be based on information from warehouse stock records, or even on supply, production backlog, and pre-existing orders records. A detailed search may be helpful to locate valid information to fill in such a field.

Embodiments of the invention provide controls to permit a user to perform searches quickly. For example, contact field 103 may display an icon 110 that the user can activate to execute a search and display results which are valid entries for the field in a subordinate or “pop-up” window 120. If one of the results is selected, the system can place its value in the contact field. For fields with more complex search parameters, activating the icon 130 may generate a “dialog” window 140 to display (and perhaps to permit adjustment of) a preconfigured set of parameters before performing the search. A control 150 may activate a list 160 of preconfigured searches (shown here as identified by various names) from which the user can select. The list may include a group of preconfigured searches available to all users 162, a group of searches available only to a single user 165, and/or a generic search without preconfigured parameters 168.

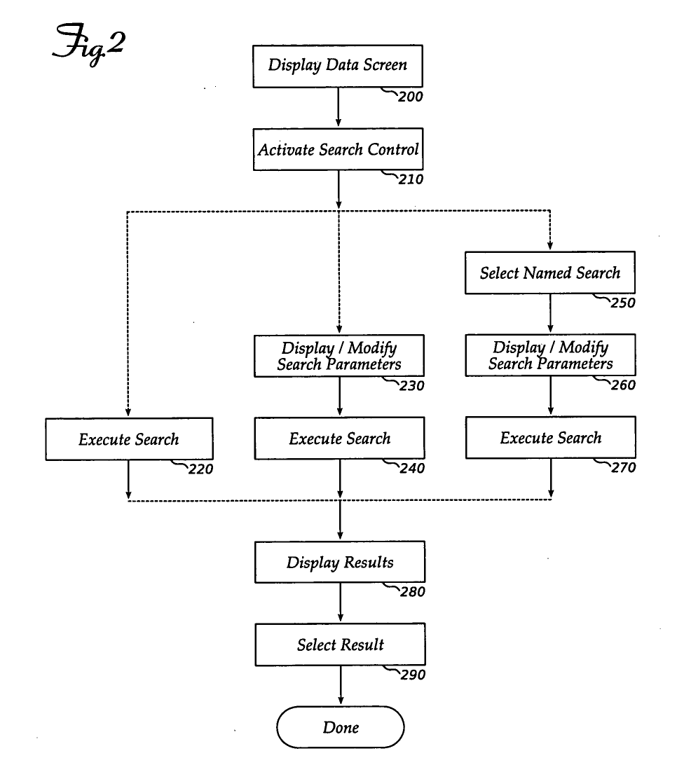

A data-entry system operating according to an embodiment of the invention may proceed as described with reference to the flow chart of FIG. 2. First, a data entry (or other system interaction) screen is displayed (200). As the clerk interacts with the screen, he may activate a search control (210). The control may execute a preconfigured search immediately (220), or present a set of preconfigured search parameters and permit the clerk to adjust one or more parameters (230) before executing the search (240). For some fields, multiple preconfigured search parameter sets may be available. The user may select one of the parameter sets (e.g. by name) (250) and then view and/or adjust parameters (260) before executing the search (270). In any case, the results found by the search are presented (280) and the clerk may select one of them to be automatically entered into the current field (290).

Note that each field of a data entry screen may be associated with a different search. Searches executed to assist in data entry, as described above, may incorporate information from other fields of a screen (or elsewhere) to produce a useful set of results for a field associated with the search. Thus, the results of these searches are different from a preconfigured set of values that may be associated with the form or data entry screen itself. For example, search icon 110 in “Contact” field 103 mentioned in the description of FIG. 1 may only be active if the “Customer” field has been filled. Without “Customer” information, it may not be possible to search for or display valid “Contact” names. On the other hand, a field that can accept a value from a fixed set, regardless of the other information entered into the screen, may display an icon similar to search icon 110, but may not execute a search when activated—instead, the values in the set can simply be displayed so that the user can select one.

Clerks in different offices or branches of a company may find different preconfigured searches to be useful. For example, clerks who deal mainly with records pertaining to European customers may find a search for telephone country codes useful, while clerks who deal with American customers may not need country codes, but may use a state-to-area-code search instead. Therefore, in some embodiments, preconfigured search parameters may differ between company branches, business units, or other subdivisions or groups of users. Similarly, a clerk who deals with a limited range of customers or products may find that an automated search, preconfigured to return only values from the limited range, may improve his efficiency significantly. Accordingly, some embodiments may permit preconfigured searches on a per-user basis.

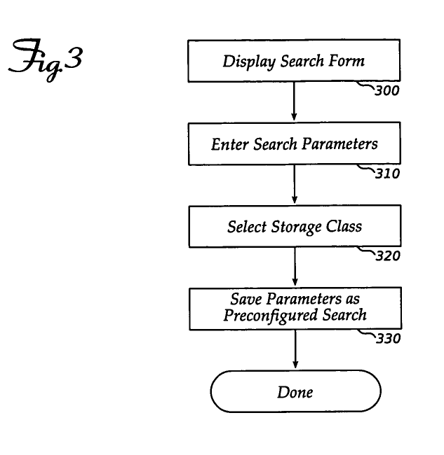

FIG. 3 shows how a preconfigured search may be prepared. First, a form containing search parameter fields is presented (300). This may be similar to a prior-art search form; such forms can be augmented with features to permit operations as described here. Search parameter fields may permit the entry of free-form text, numerical data or ranges, or selection from among a limited set of choices. Boolean fields may also be used to adjust the operation of a search.

The search preparer makes entries in one or more of the search parameter fields (310). In one embodiment, the preparer can lock certain fields or mark them hidden, so that a user cannot later alter those portions of the search before executing the search. If all the fields are locked or hidden, then the search may be executed directly when a user activates it, instead of presenting the parameters and allowing modifications.

Next, the preparer selects a storage class (320) to indicate whether the preconfigured search is to be available only to one user (perhaps the preparer himself), to users in a certain group, or to all users. The system stores the search parameters (and any “lock” information) in a database or other storage facility as a preconfigured search (330). The search may be associated with a descriptive name or other identifier to assist users in selecting appropriate parameter sets. Some systems may implement a permission or privilege scheme so that only a limited number of users can create preconfigured search settings that are visible to groups of users or to all users.

In one embodiment, a generic prior-art search parameter entry screen may be augmented with a button, selector or other control to permit the currently-configured search to be saved. Alternatively, a search results display screen may be provided with such a button, selector or other control, so that search parameters can be adjusted while performing repeated searches, and saved when the desired results are obtained. Thus, the search facilities of an existing system may be extended with an embodiment of the invention relatively easily.

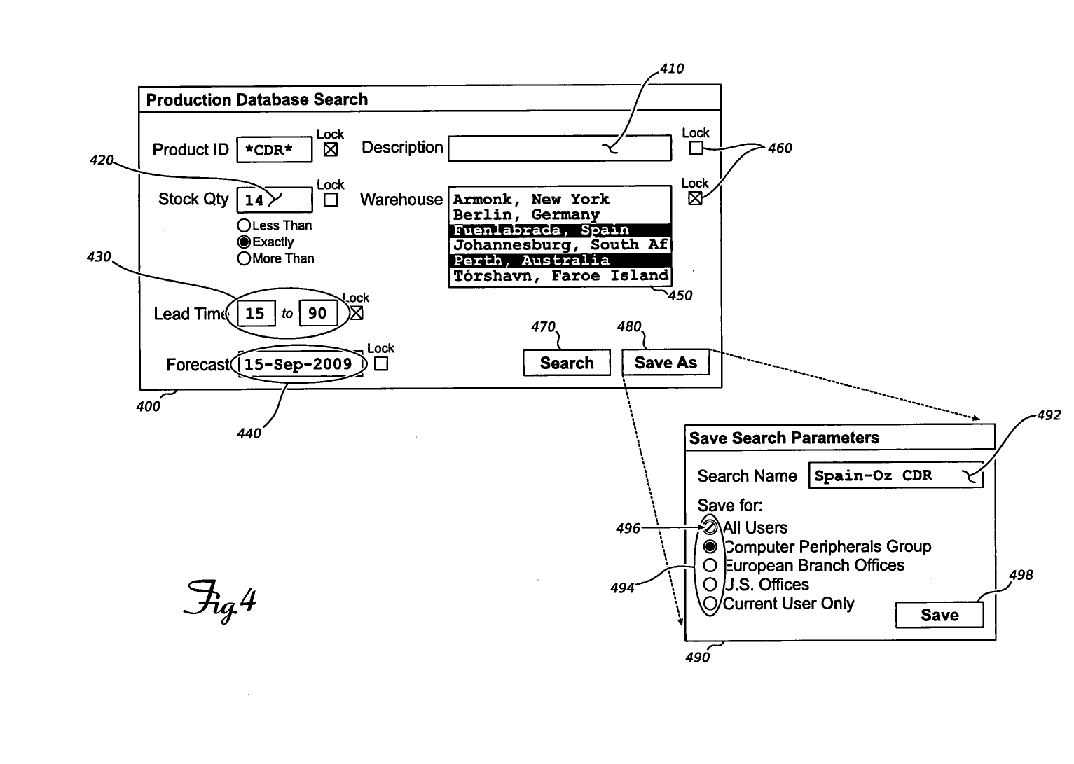

FIG. 4 shows a search parameter entry screen 400 with added controls to implement methods according to an embodiment of the invention. The screen shown includes fields to permit the user to search for records in a production database. Of course, similar search screens can be prepared for most types of databases. This example shows several field types: free-form text 410, numeric 420 and numeric range 430, date 440, and sets of fixed values 450. Each field may be provided with a “lock” flag or attribute (examples at 460) to indicate that a value in that field of a preconfigured search should not be modified by a user of the preconfigured search.

A search using the current parameter settings can be executed immediately with the “Search” button (470), or the parameters can be saved for the benefit of future users with the “Save As” button (480). Saving the current parameters may lead to a dialog 490 that prompts the operator to specify a name for the search (492) and to select a storage class (494). In this example, the “All Users” choice (496) is unavailable because the operator preparing the search lacks appropriate privileges to make the search so widely available. The preconfigured search parameters can be saved with the “Save” button 498.

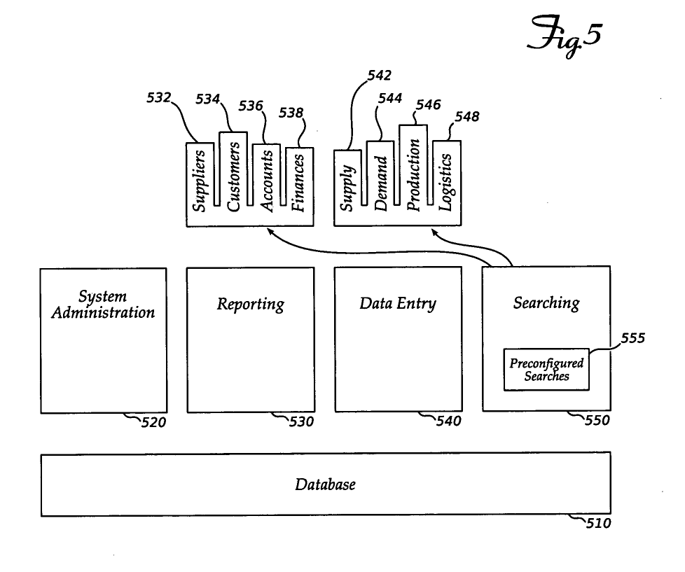

As mentioned above, a configurable search facility can be added to an existing search and data entry system relatively easily. In fact, in a carefully architected system, large portions of the existing search facilities will share software codes, and so most or all search instances can be upgraded simultaneously by adding the new functionality to the basic modules. FIG. 5 shows an overview of a system architecture, including locations where preconfigured search extensions can be added to good effect.

Systems will often be built upon a database facility 510. Databases that implement the Structured Query Language (“SQL”) are widely used in this role, although other database technologies can also support embodiments of the invention. Atop the database layer are basic system facilities such as system administration 520, reporting 530, data entry 540 and searching 550. The basic search facilities can usefully be extended with preconfigured searches 555 as disclosed herein.

The foundation consisting generally of the logical blocks discussed above can support a variety of vertical applications. This figure shows some elements of one such application, supply chain management (“SCM”). An SCM application collects and integrates data from various aspects of a business's operation and provides methods to analyze the data to understand the current situation, to forecast, and to compare competing options. Data entry 540 may include collection of information relating to supply of input materials 542, demand for processed goods 544, production or manufacturing status 546, and logistics 548 (what items are where). Reporting 530 may deliver raw or derivative information from the database to answer questions about suppliers 532, customers 534, accounts 536 and finances 538. Search facilities 550 may support data entry 540 by locating information necessary to complete various data entry forms, as discussed in relation to FIG. 1, and may also help focus reporting 530 by selecting interesting subsets of the information in the database. The locating and selecting operations can be based on preconfigured search parameter sets; the sets can optionally be viewed and modified by a user before execution, or can be executed immediately upon selection.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (“CD-ROM”), Read-Only Memory (“ROM”), Random Access Memory (“RAM”), Electrically Erasable Programmable Read-Only Memory (“EEPROM”), and a memory device that permits transmission over the Internet.

One embodiment of the invention includes the machine-readable medium described above and a machine to read and execute the instructions. Such a machine may be a general- or special purpose computing system including one or more processors, memory, a mass storage device, input and output devices, and optionally a communication facility to exchange data with other cooperating systems.

The applications of the present invention have been described largely by reference to specific examples and in terms of particular allocations of functionality to certain hardware and/or software components. However, those of skill in the art will recognize that preconfigured search parameter preparation and use can also be achieved by software and hardware that distribute the functions of embodiments of this invention differently than herein described. Such variations and implementations are understood to be captured according to the following claims.

I claim:

1. A method comprising:
accepting at least one entry from a user for at least one of a plurality of search parameters;
receiving a selection of one of a plurality of storage classes; and
storing the at least one entry as a preconfigured search according to the selected storage class.

2. The method of claim 1 wherein the plurality of storage classes comprises:
a class whose contents are available to one user; and
a class whose contents are available to a plurality of users.

3. The method of claim 1, further comprising:
accepting an identifier of the at least one entry; and
storing the identifier with the at least one entry.

4. The method of claim 1, further comprising:
determining a privilege level of the user; and
eliminating at least one storage class from the plurality of storage classes if the privilege level is below a predefined level.

5. The method of claim 1 wherein each of the at least one entries comprises an indicator to control whether a user of the preconfigured search may alter the entry before executing a search.

6. A method comprising:
retrieving at least one preconfigured search parameter value from a database;
displaying a search dialog containing the at least one search parameter value if at least one of the at least one search parameter values is not locked; and
executing a search based on the at least one search parameter value.

7. The method of claim 6, further comprising:
retrieving a first group of preconfigured search parameter sets from the database;
retrieving a second group of preconfigured search parameter sets from the database, the second group associated with a user;
presenting a list of preconfigured search parameter sets including the first group and the second group; and
accepting a selection of a preconfigured search parameter set from the list.

8. The method of claim 7, further comprising:
executing a search based on the at least one search parameter value after accepting the selection if all of the search parameters of the selected preconfigured search parameter set are locked.

9. A computer-readable medium containing instructions to cause a programmable processor to perform operations comprising:
collecting information about operations of a business;
selecting a subset of the information that matches a preconfigured search query; and
displaying the subset.

10. The computer-readable medium of claim 9 containing additional instructions to cause the programmable processor to perform operations comprising:
displaying a list of preconfigured search queries; and
accepting a selection of the preconfigured search query from the list.

11. The computer-readable medium of claim 9 containing additional instructions to cause the programmable processor to perform operations comprising:
displaying a plurality of search parameters of the preconfigured search query; and
accepting modifications to at least one of the plurality of search parameters before performing the selecting operation.

12. The computer-readable medium of claim 9 containing additional instructions to cause the programmable processor to perform operations comprising:
accepting entries for at least one of a plurality of search fields;
storing the entries as a preconfigured search query, the preconfigured search query to be associated with an identifier and a group.

13. The computer-readable medium of claim 9 wherein the information about operations of the business comprises:
a supply of input materials;
a demand for processed goods;
a manufacturing status; and
logistics.

14. A system comprising:
a mass storage device to store a plurality of preconfigured search queries;
an output device to display some of the preconfigured search queries;
an input device to permit a selection of one of the preconfigured search queries;
a mass storage device to contain data in a database; and
a processor to locate data in the database that corresponds to the selected one of the preconfigured search queries.

15. The system of claim 14, further comprising:
privilege logic to determine an access level of a user; and
preconfigured search parameter storage logic to store a preconfigured search query in one of a plurality of groups, wherein accessibility of each group depends upon the access level of the user.

16. The system of claim 14 wherein a preconfigured search query comprises:
a value for at least one of a plurality of search fields;
a locking indicator to control whether a user may alter the value; and
a name to identify the preconfigured search query.
